(19) United States
(12) Patent Application Publication
(10) Pub. No.: US 2024/0429828 A1
(43) Pub. Date: Dec. 26, 2024

(54) POWER CONVERSION DEVICE AND METHOD

(71) Applicant: HL MANDO CORPORATION, Gyeonggi-do (KR)

(72) Inventor: Dongok MOON, Gyeonggi-do (KR)

(21) Appl. No.: 18/522,205

(22) Filed: Nov. 28, 2023

(30) Foreign Application Priority Data
Jun. 22, 2023 (KR) 10-2023-0080321

(51) Int. Cl. H02M 3/335; H02M 3/00

(52) U.S. Cl. CPC H02M 3/33573; H02M 3/01; H02M 3/33576

(57) ABSTRACT

There may provide a power conversion device and method capable of performing control of a stable output gain from a light load to a full load by controlling using a complex modulation method in which a phase modulation mode and a frequency modulation mode are performed by a controller.

### CROSS REFERENCE TO RELATED APPLICATION

This application claims priority to Korean Patent Application No. 10-2023-0080321, filed on Jun. 22, 2023, which is hereby incorporated by reference for all purposes as if fully set forth herein.

### TECHNICAL FIELD

Various embodiments of the present disclosure generally relate to a power conversion device and method for converting input direct current (DC) power to be stepped up or stepped down.

### BACKGROUND

There is increasing an interest in eco-friendly vehicles such as electric vehicles and plug-in hybrid vehicles for solving environmental and energy problems.

An electric vehicle (EV) and a plug-in hybrid electric vehicle (PHEV) may have a high-voltage battery and an on-board charger (OBC) for charging the high-voltage battery.

The OBC may perform a function of charging a high-voltage battery, which is a main battery. And, the OBC may include a power factor correction (PFC) circuit and a LLC converter.

The LLC converter generally includes a resonant circuit (i.e., a resonant tank) composed of a resonant inductance (Lr), a magnetization inductance (Lm), and a resonant capacitance (Cr). When the resonant circuit operates at a resonant frequency (e.g., if the output gain is 1), the LLC converter may have the highest efficiency.

Since the output gain of the LLC converter varies according to a switching frequency, a specific switching frequency at which the output gain is 1 is generally used.

In the case of an LLC converter to which a variable frequency control method is applied, the switching frequency may be varied according to the magnitude of the output voltage to be controlled.

However, if the switching frequency is varied, since the LLC converter or CLLC converter which controls the output through frequency control has a characteristic that a slope of the output variation according to the load is gentle, the frequency may increase greatly at light load.

### SUMMARY

According to some embodiments of the present disclosure, there may provide a power conversion device and method capable of providing stable output gain control from light load to full load by controlling using a complex modulation scheme in which a controller performs a phase modulation mode and a frequency modulation mode.

In accordance with an aspect of the present disclosure, there is provided a power conversion device including: a first bridge switching unit which is connected to a primary side coil of a transformer and performs full bridge switching; a first resonance circuit unit comprising a first capacitor and a first inductor disposed between the primary side coil of the transformer and the first bridge switching unit; a second bridge switching unit which is connected to a secondary side coil of the transformer and performs full bridge switching; a second resonance circuit unit comprising a second capacitor and a second inductor disposed between the secondary side coil of the transformer and the second bridge switching unit; and a controller configured to control the first bridge switching unit and the second bridge switching unit so as to generate a rectified resonance voltage by changing a voltage direction at a specific period through the first bridge switching unit or generate a rectified regenerative voltage by changing a voltage direction at a specific period through the second bridge switching unit, wherein the controller may control the first bridge switching unit or the second bridge switching unit to perform a phase modulation mode and a frequency modulation mode.

The first bridge switching unit may include a first switching element and a second switching element serially connected to each other, and a third switching element and a fourth switching element connected in parallel to the first switching element and the second switching element, and serially connected to each other. In addition, the first resonance circuit unit may include the first inductor connected between a first node between the first switching element and the second switching element and the primary side coil of the transformer, and the first capacitor connected between a second node between the third switching element and the fourth switching element and the primary side coil of the transformer, wherein the plurality of switching elements may be turned on or turned off in synchronization with the period.

In addition, if the first bridge switching unit operates in the phase modulation mode or the frequency modulation mode, turn-on timings of the first switching element and the second switching element may not overlap, and turn-on timings of the third switching element and the fourth switching element may not overlap.

The first resonant circuit unit may connect the first inductor, the primary side coil of the transformer, and the first capacitor in series.

In addition, the second bridge switching unit may include a fifth switching element and a sixth switching element serially connected to each other, and a seventh switching element and a eighth switching element connected in parallel to the fifth switching element and the sixth switching element, and serially connected to each other, and the second resonance circuit unit may include the second inductor connected between a third node between the fifth switching element and the sixth switching element and the secondary side coil of the transformer, and the second capacitor connected between a fourth node between the seventh switching element and the eighth switching element and the secondary side coil of the transformer. In this case, the plurality of switching elements may be turned on or turned off in synchronization with the period.

In addition, if the second bridge switching unit operates in the phase modulation mode or the frequency modulation mode, turn-on timings of the fifth switching element and the sixth switching element may not overlap, and turn-on timings of the seventh switching element and the eighth switching element may not overlap.

The second resonant circuit unit may connect the second inductor, the secondary side coil of the transformer, and the second capacitor in series.

When converting power from the primary coil of the transformer to the secondary coil of the transformer or converting power from the secondary coil of the transformer to the primary coil of the transformer, the controller may control the first bridge switching unit and the second bridge switching unit to perform the phase modulation mode of modulating a phase to a target value and perform the frequency modulation mode when the phase is modulated to the target value.

When converting power from the primary coil of the transformer to the secondary coil of the transformer or converting power from the secondary coil of the transformer to the primary coil of the transformer, the controller may control the first bridge switching unit and the second bridge switching unit to perform the phase modulation mode of modulating a phase to a target value and perform the frequency modulation mode so as to overlap with a part of sections in which the phase is modulated to the target value.

In the frequency modulation mode, an input frequency may be decreased to a target value within a preset range.

In the phase modulation mode, when generating the resonance voltage, the first switching element and the fourth switching element may be turned on, and the second switching element and the third switching element may be turned off in a first section of the period.

In the phase modulation mode, when generating the resonance voltage, the first switching element and the third switching element may be turned on, and the second switching element and the fourth switching element may be turned off in a second section of the period.

In the phase modulation mode, when generating the resonance voltage, the second switching element and the third switching element may be turned on, and the first switching element and the fourth switching element may be turned off in a third section of the period.

In the phase modulation mode, when generating the resonance voltage, the second switching element and the fourth switching element may be turned on, and the first switching element and the third switching element may be turned off in a fourth section of the period.

In the phase modulation mode, when generating the resonance voltage, diodes of the fifth switching element and the eighth switching element may be conducted, and diodes of the sixth switching element and the seventh switching element may be insulated in a first section of the period.

In the phase modulation mode, when generating the resonance voltage, diodes of the fifth switching element and the eighth switching element may be conducted, and diodes of the sixth switching element and the seventh switching element may be insulated in a second section of the period.

In the phase modulation mode, when generating the resonance voltage, diodes of the sixth switching element and the seventh switching element may be conducted, and diodes of the fifth switching element and the eighth switching element may be insulated in a third section of the period.

In the phase modulation mode, when generating the resonance voltage, diodes of the fifth switching element and the eighth switching element may be conducted, and diodes of the sixth switching element and the seventh switching element may be insulated in a fourth section of the period.

In accordance with an aspect of the present disclosure, there is provided a power conversion method for converting input direct current power to step-up or step-down direct current power using a power conversion device including performing, by a controller, a phase modulation mode by controlling a first bridge switching unit or a second bridge switching unit, and performing, by the controller, a frequency modulation mode by controlling the first bridge switching unit or the second bridge switching unit. In this case, the performing a phase modulation mode may include performing a phase modulation mode of modulating a phase to a target value, and the performing a frequency modulation mode may include performing a frequency modulation mode of decreasing an input frequency to a target value within a preset range.

In addition, the performing a phase modulation mode may include a first step in which the controller turns on a first switching element and a fourth switching element and turns off a second switching element and a third switching element in a first section of a period, a second step in which the controller turns on the first switching element and the third switching element and turns off the second switching element and the fourth switching element in a second section of the period, a third step in which the controller turns on the second switching element and the third switching element and turns off the first switching element and the fourth switching element in a third section of the period, and a fourth step in which the controller turns on the second switching element and the fourth switching element and turns off the first switching element and the third switching element in a fourth section of the period.

According to certain embodiments of the present disclosure, it is possible to provide a power conversion device and method capable of performing a stable output gain control from a light load to a full load by controlling using a complex modulation method in which a phase modulation mode and a frequency modulation mode are performed by a controller.

### BRIEF DESCRIPTION OF THE DRAWINGS

FIG. 1 is a circuit diagram of a power conversion device according to an embodiment of the present disclosure.

FIG. 2 is a diagram for illustrating operation signals of switching elements according to a phase modulation mode and a frequency modulation mode according to an embodiment of the present disclosure.

FIGS. 3 to 6 are circuit diagrams for illustrating current flows according to the operation of each switching element according to an embodiment of the present disclosure.

FIGS. 7 and 8 are graphs for illustrating main waveforms according to phase modulation mode and frequency modulation mode operations according to an embodiment of the present disclosure.

FIG. 9 is a graph for illustrating an output according to phase modulation mode and frequency modulation mode operations according to an embodiment of the present disclosure.

FIG. 10 is a graph for illustrating main waveforms according to phase modulation mode and frequency modulation mode operations when generating a resonance voltage according to an embodiment of the present disclosure.

FIG. 11 is a graph for illustrating main waveforms according to phase modulation mode and frequency modulation mode operations when generating regenerative voltage according to an embodiment of the present disclosure.

FIG. 12 is a graph for illustrating operations of phase modulation mode and frequency modulation mode according to another embodiment of the present disclosure.

FIG. 13 is a graph for illustrating a comparison of outputs according to control schemes of exemplary embodiments of the present disclosure.

FIG. 14 is a flowchart for illustrating a power conversion method according to an embodiment of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

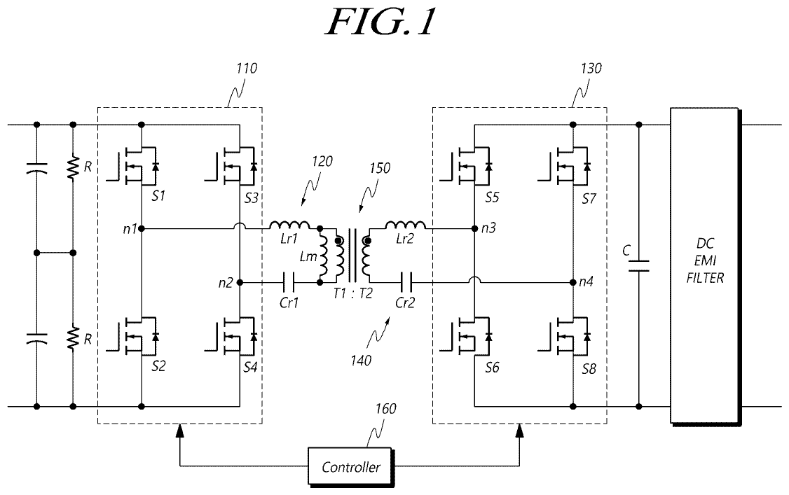

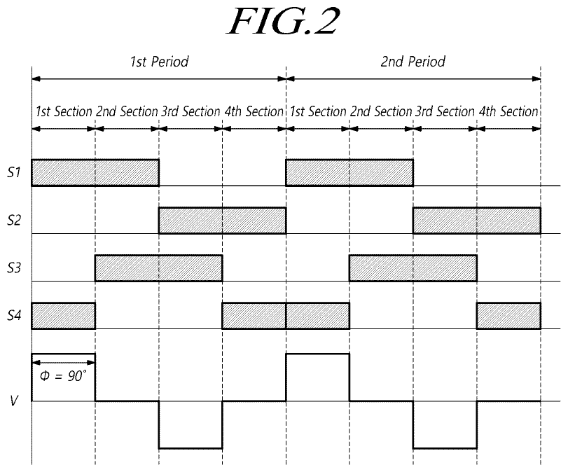

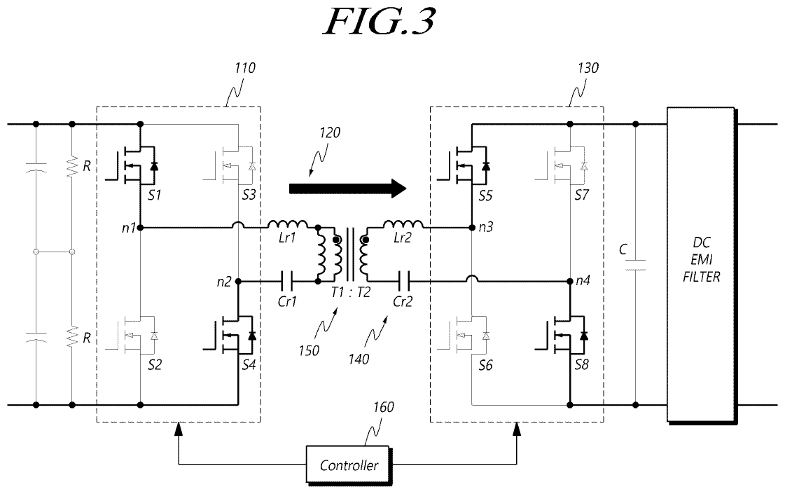

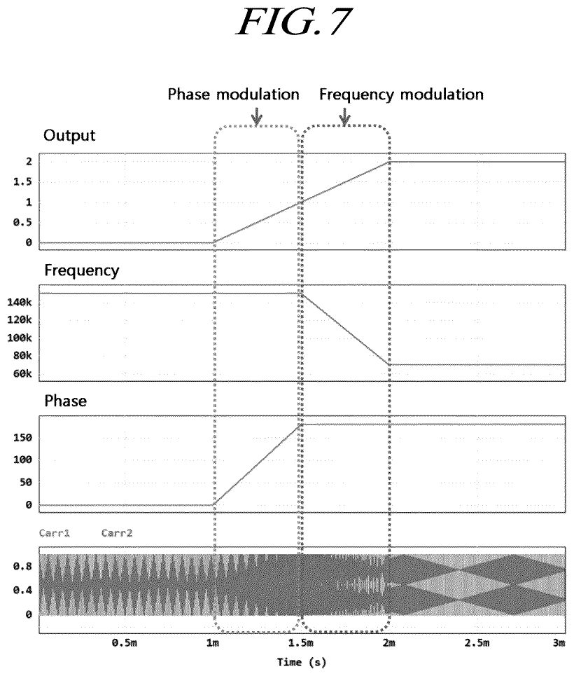

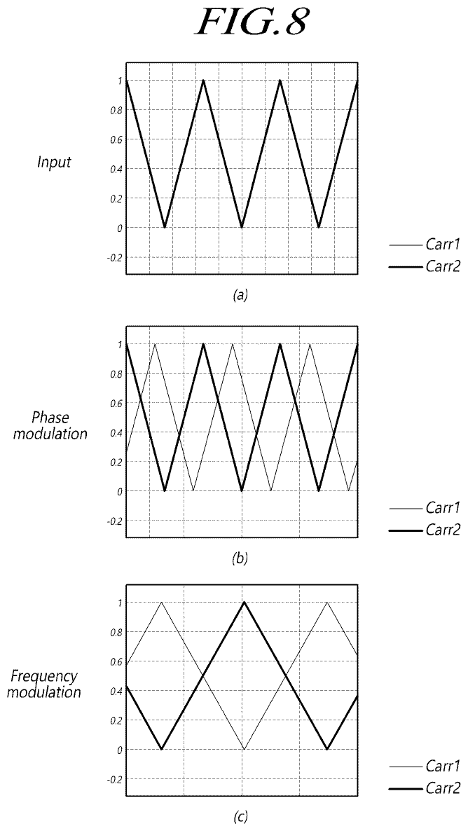

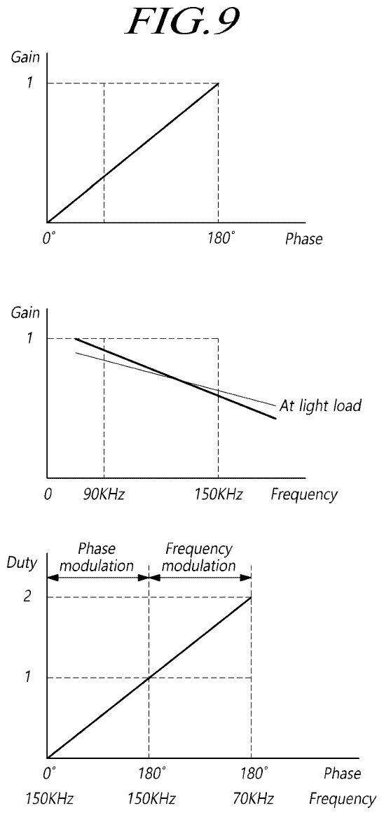

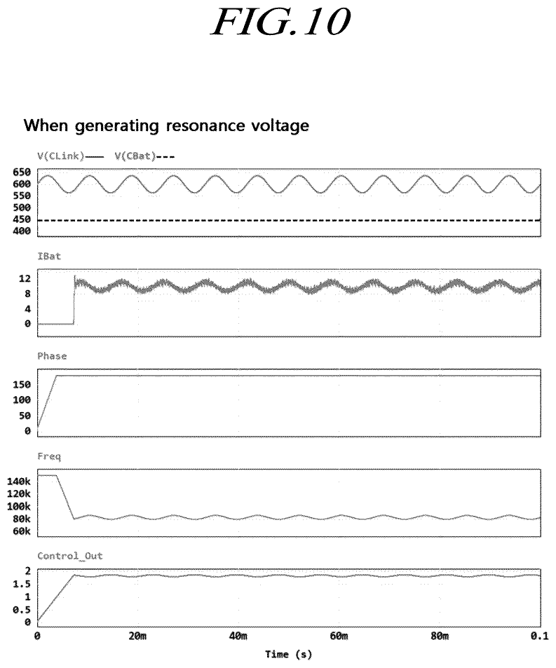

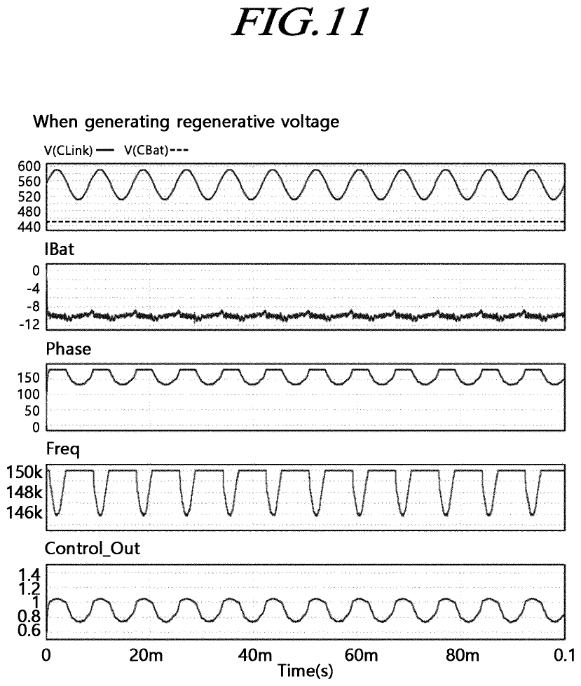

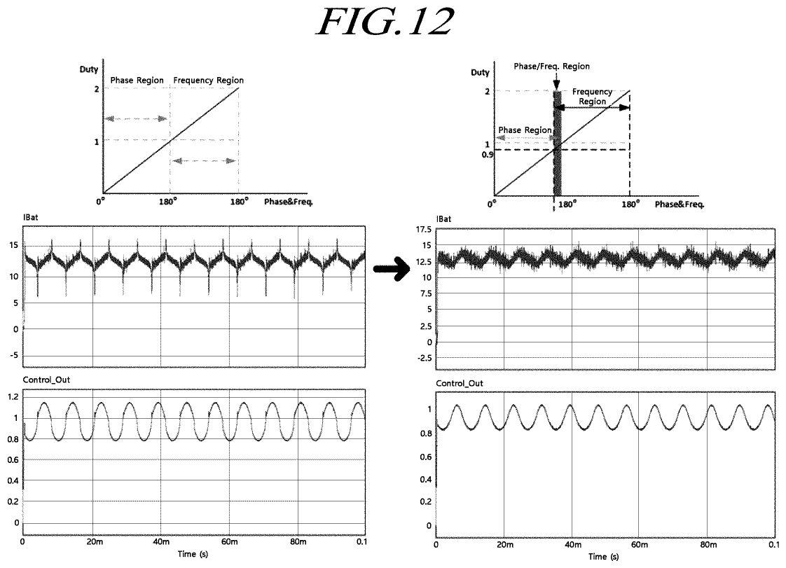

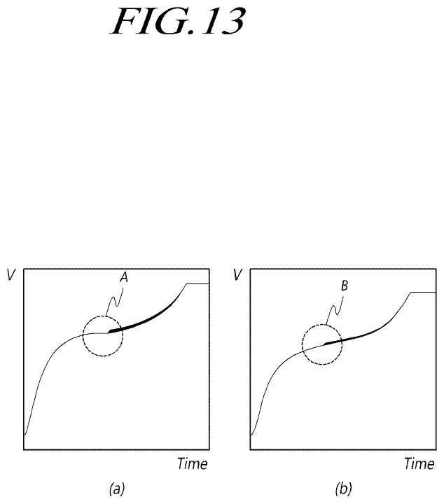

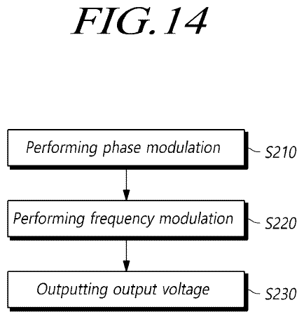

FIG. 1 is a circuit diagram of a power conversion device according to an embodiment of the present disclosure, FIG. 2 is a diagram for illustrating operation signals of switch elements according to a phase modulation mode and a frequency modulation mode according to an embodiment of the present disclosure, FIGS. 3 to 6 are circuit diagrams for illustrating current flows according to the operation of each switch element according to an embodiment of the present disclosure, FIGS. 7 and 8 are graphs for illustrating main waveforms according to phase modulation mode and frequency modulation mode operations according to an embodiment of the present disclosure, FIG. 9 is a graph for illustrating an output according to phase modulation mode and frequency modulation mode operations according to an embodiment of the present disclosure, FIG. 10 is a graph for illustrating main waveforms according to phase modulation mode and frequency modulation mode operations when generating a resonance voltage according to an embodiment of the present disclosure, FIG. 11 is a graph for illustrating main waveforms according to phase modulation mode and frequency modulation mode operations when generating regenerative voltage according to an embodiment of the present disclosure, FIG. 12 is a graph for illustrating operations of a phase modulation mode and a frequency modulation mode according to another embodiment of the present disclosure, FIG. 13 is a graph illustrating a comparison of outputs according to control schemes of exemplary embodiments of the present disclosure, and FIG. 14 is a flowchart for illustrating a power conversion method according to an embodiment of the present disclosure.

A power conversion device according to an embodiment of the present disclosure may include a first bridge switching unit (or a first bridge switch unit) 110, a first resonance circuit unit 120, a second bridge switching unit (or a second bridge switch unit) 130, a second resonance circuit unit 140, and a controller 160. The first bridge switching unit 110 is connected to a primary side coil T1 of a transformer 150 and is configured to perform full bridge switching. The first resonance circuit unit 120 may include, for example, but not limited to, a first capacitor Cr1 and a first inductor Lr1 disposed between the primary side coil T1 of the transformer 150 and the first bridge switching unit 110. The second bridge switching unit 130 is connected to a secondary side coil T2 of the transformer 150 and is configured to perform full bridge switching. The second resonance circuit unit 140 may include, for example, but not limited to, a second capacitor Cr2 and a second inductor Lr2 disposed between the secondary side coil T2 of the transformer 150 and the second bridge switching unit 130. The controller 160 is configured to control the first bridge switching unit 110 and the second bridge switching unit 130 so as to generate a rectified resonance voltage by changing a voltage direction at a specific period through the first bridge switching unit 110 or generate a rectified regenerative voltage by changing a voltage direction at a specific period through the second bridge switching unit 130. The controller 160 may control the first bridge switching unit 110 and/or the second bridge switching unit 130 to perform a phase modulation mode and a frequency modulation mode.

As a power conversion device according to an embodiment of the present disclosure, there is exemplified a type or form in which DC-DC converters are implemented in both directions so as to allow charging and discharging in both directions.

In the case of a power conversion device implemented in both directions as described above, there may function in a buck mode and a boost mode depending on directions.

However, a power conversion device according to an embodiment of the present disclosure may be configured to include an LLC converter and an output bridge (e.g., a full-bridge or half-bridge type using diodes).

The power conversion device may include the first bridge switching unit 110, a CLLC resonant tank connected to the first bridge switching unit 110, and the second bridge switching unit 130 connected to the CLLC resonant tank.

When the high voltage battery is charged, the output of the first bridge switching unit 110 may be transferred to the CLLC resonance tank, and then transferred to the second bridge switching unit 130. The output of the second bridge switching unit 130 may be transferred to the high voltage battery.

When the high voltage battery is discharged, the power of the high voltage battery may be transferred to the first bridge switching unit 110 via the second bridge switching unit 130 and the CLLC resonance tank.

As shown in FIG. 1, the power conversion device is configured to convert input DC power into step-up (i.e., boosted) or step-down DC power. The power conversion device shown in FIG. 1 may include, between a DC power supply and the high voltage battery, the first bridge switching unit 110 and the first resonant circuit unit 120, the second bridge switching unit 130, the second resonant circuit unit 140, a transformer 150, and the controller 160.

The CLLC resonance tank connected between the first bridge switching unit 110 and the second bridge switching unit 130 in FIG. 1 may include the first resonance circuit unit 120, the second resonance circuit unit 140, and the transformer 150.

The first bridge switching unit (or the first bridge switch unit) 110 according to the present embodiment may include, for example, but not limited to, first to fourth switching elements (or first to fourth switches) S1 to S4. The first switching element (or the first switch) S1 and the second switching element (or the second switch) S2 may be connected in series with each other. The third switching element (or the third switch) S3 and the fourth switching element (or the fourth switch) S4 may be connected in parallel to the first switching element S1 and the second switching element S2 and may be serially connected to each other.

The first resonant circuit unit 120 may include a first inductor Lr1 and a first capacitor Cr1. The first inductor Lr1 may be connected between a first node n1 between the first switching element S1 and the second switching element S2 and the primary side coil T1 of the transformer 150. The first capacitor Cr1 may be connected between a second node n2 between the third switching element S3 and the fourth switching element S4 and the primary side coil T1 of the transformer 150.

In this exemplary embodiment, the first resonant circuit unit 120 may connect the first inductor Lr1, the primary side coil T1 of the transformer 150, and the first capacitor Cr1 in series.

Here, the plurality of switching elements S1, S2, S3 and S4 may be turned on or turned off in synchronization at a specific or preset period, and may be switched according to the on/off control of the controller 160.

The second bridge switching unit 130 may include, for instance, but not limited to, fifth to eighth switching elements (or fifth to eighth switches) S5 to S8. The fifth switching element (or the fifth switch) S5 and the sixth switching element (or the sixth switch) S6 may be connected in series with each other. The seventh switching element (or the seventh switch) S7 and the eighth switching element (or the eighth switch) S8 may be connected in parallel to the fifth switching element S5 and the sixth switching element S6 and may be connected in series to each other.

In addition, the second resonance circuit unit 140 may include a second inductor Lr2 and a second capacitor Cr2. The second inductor Lr2 may be connected between a third node n3 between the fifth switching element S5 and the sixth switching element S6 and the secondary side coil T2 of the transformer 150. The second capacitor Cr2 may be connected between a fourth node n4 between the seventh switching element S7 and the eighth switching element S8 and the secondary side coil T2 of the transformer 150.

In this exemplary embodiment, the second resonance circuit unit 140 may connect the second inductor Lr2, the secondary coil T2 of the transformer 150, and the second capacitor Cr2 in series.

Here, the plurality of switching elements or switches S5, S6, S7 and S8 may be turned on or turned off in synchronization at a specific or preset period, and may be controlled to be switched according to the on/off control of the controller 160.

The number and configuration of switching elements of the first bridge switching unit 110 and the second bridge switching unit 130 are not limited to the exemplary embodiment shown in FIG. 1, and the switching elements or switches may be arranged in a half-bridge form rather than a full-bridge form.

A magnetization inductor Lm shown in FIG. 1 may be a magnetization inductance component equivalently existing or included inside the transformer 150 as an inductor.

The controller 160 may be configured to control the first bridge switching unit 110 to change a direction of the voltage at specific periods through the first bridge switching unit 110 and input to the first resonance circuit unit 120, and generate the rectified resonance voltage through the second bridge switching unit 130. The controller 160 may be implemented with one or more memories configured to store computer executable instructions and/or one or more processors configured to execute the computer executable instructions stored in the memory.

In addition, the controller 160 may be configured to control the second bridge switching unit 130 to change a direction of the voltage at specific periods through the second bridge switching unit 130 and input to the second resonance circuit unit 140, and generate the rectified regenerative voltage through the first bridge switching unit 110.

In this exemplary embodiment, the controller 160 may control the first bridge switching unit 110 or the second bridge switching unit 130 to perform a phase modulation mode for modulating a phase and a frequency modulation mode for modulating a frequency.

For instance, when converting power from the primary side coil T1 of the transformer 150 to the secondary side coil T2 of the transformer 150, the controller 160 according to the present embodiment may control the first bridge switching unit 110 and the second bridge switching unit 130 to perform a phase modulation mode for modulating a phase to a preset target value, and, if the phase is modulated to a preset target value, perform a frequency modulation mode for reducing an input frequency to a target value within a preset range.

In addition, when converting power from the secondary side coil T2 of the transformer 150 to the primary side coil T1 of the transformer 150, the controller 160 according to the present embodiment may control the first bridge switching unit 110 and the second bridge switching unit 130 to perform a phase modulation mode for modulating a phase to a preset target value, and, if the phase is modulated to a preset target value, perform a frequency modulation mode for reducing an input frequency to a target value within a preset range.

Referring to FIG. 2, the controller 160 may control the operation signal so that switching elements or switches are turned on or off in each section of a specific period in the phase modulation mode.

As an example, referring to FIG. 3, when generating the resonance voltage in the phase modulation mode of this exemplary embodiment of FIG. 3, the controller 160 may control the switching operation to turn on the first switching element S1 and the fourth switching element S4 and to turn off the second switching element S2 and the third switching element S3 in a first section of one period.

At the same time, in the first section of the first period, the diodes of the fifth switching element S5 and the eighth switching element S8 may be conducted (i.e., a state in which electricity is flowing in the forward direction), and the diodes of the sixth switching element S6 and the seventh switching element S7 may be insulated (i.e., a state where electricity does not conduct in the opposite direction).

Here, the diode is a device configured to allow current to flow in one side or direction and prevent or block from flowing in the other side or direction. That is, the diode may be conducted in the forward direction and insulated in the opposite direction.

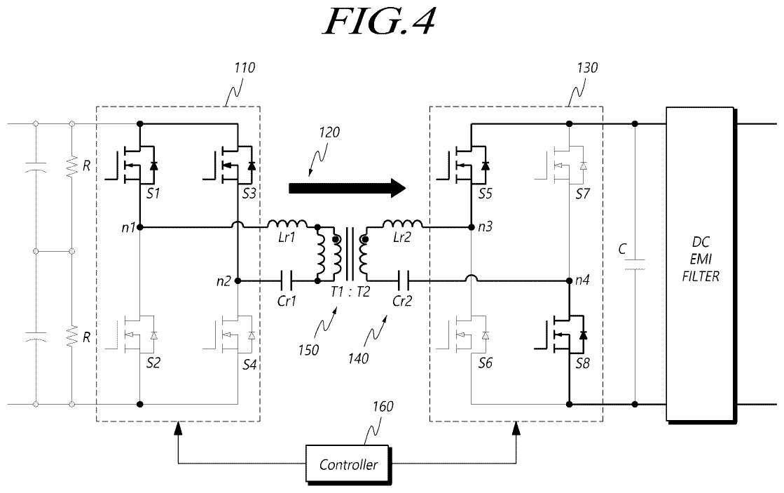

In addition, referring to FIG. 4, in the phase modulation mode of this exemplary embodiment of FIG. 4, the controller 160 may control the switching operation to turn on the first switching element S1 and the third switching element S3 and to turn off the second switching element S2 and the fourth switching element S4 in a second section of one period.

At the same time, in the second section of one period, the diodes of the fifth switching element S5 and the eighth switching element S8 may be conducted (i.e., a state in which electricity is flowing in the forward direction), and the diodes of the sixth switching element S6 and the seventh switching element S7 may be insulated (i.e., a state where electricity does not conduct in the opposite direction).

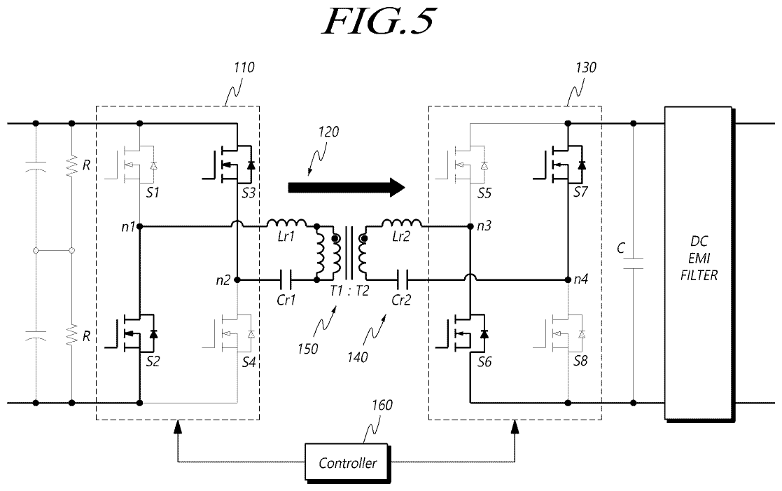

In addition, referring to FIG. 5, in the phase modulation mode of this exemplary embodiment of FIG. 5, the controller 160 may control the switching operation to turn on the second switching element S2 and the third switching element S3 and to turn off the first switching element S1 and the fourth switching element S4 in a third section of one period.

At the same time, in the third section of one period, the diodes of the sixth switching element S6 and the seventh switching element S7 may be conducted (i.e., a state in which electricity is flowing in the forward direction), and the diodes of the fifth switching element S5 and the eighth switching element S8 may be insulated (i.e., a state where electricity does not conduct in the opposite direction).

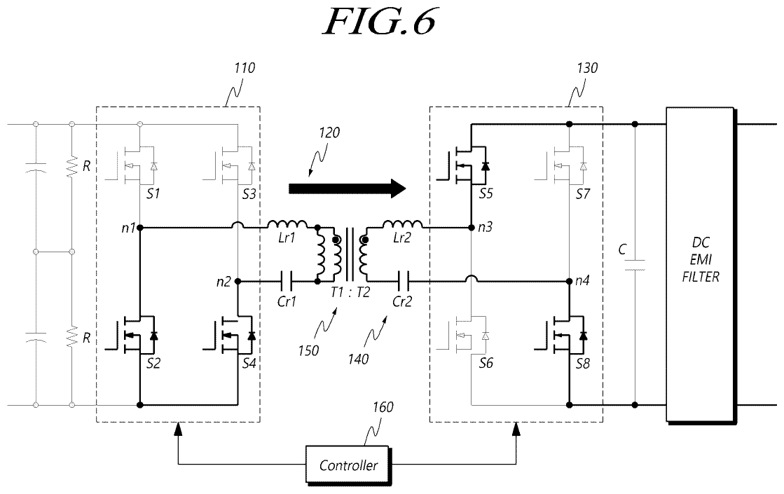

In addition, referring to FIG. 6, in the phase modulation mode of this exemplary embodiment of FIG. 6, the controller 160 may control the switching operation to turn on the second switching element S2 and the fourth switching element S4 and to turn off the first switching element S1 and the third switching element S3 in a fourth section of one period.

At the same time, in the fourth section of one period, the diodes of the fifth switching element S5 and the eighth switching element S8 may be conducted (i.e., a state in which electricity is flowing in the forward direction), and the diodes of the sixth switching element S6 and the seventh switching element S7 may be insulated (i.e., a state where electricity does not conduct in the opposite direction).

In addition, when generating a regenerative voltage in the phase modulation mode of this exemplary embodiment, the controller 160 may control the second bridge switching unit 130 symmetrically with respect to the transformer 150.

In the case that the first bridge switching unit 110 operates in the phase modulation mode or the frequency modulation mode, the turn-on timings of the first switching element S1 and the second switching element S2 may not overlap each other, and the turn-on timings of the third switching element S3 and the fourth switching element S4 may not overlap each other.

In addition, when the second bridge switching unit 130 operates in the phase modulation mode or the frequency modulation mode, the turn-on timings of the fifth switching element S5 and the sixth switching element S6 may not overlap each other, and the turn-on timings of the seventh switching element S7 and the eighth switching element S8 may not overlap each other.

As described above, the power conversion device according to an embodiment of the present disclosure may perform a phase modulation mode in which the phase is modulated to a preset target value, and, when the phase is modulated to the preset target value, may perform a frequency modulation mode that reduces or decreases the input frequency to a target value within a preset range.

Referring to FIG. 7, the power conversion device according to an embodiment of the present disclosure may perform a phase modulation mode for modulating the phase to a preset target value, and may perform a frequency modulation mode of modulating the frequency to a target value, for instance, decreasing the input frequency to a target value within a preset range when the phase is modulated to the preset target value, thereby performing a stable output gain control.

FIG. 8(a) illustrates an input voltage waveform, FIG. 8(b) illustrates a waveform in a state in which the phase of the input voltage is modulated to the preset target value, and FIG. 8(c) shows a waveform in a state in which the input frequency is decreased to a target value within a preset range.

As described above, in the power conversion device according to an embodiment of the present disclosure, the controller 160 may use a complex modulation method that performs a phase modulation mode and a frequency modulation mode in order to acquire a stable output despite changes in a load from light load to full load.

Referring to FIG. 9, in the power conversion device according to an embodiment of the present disclosure, the gain may increase as the phase changes from 0° to 180° in the phase modulation mode, and the gain may increase as the frequency changes from 150 KHz to 70 KHz in the frequency modulation

Therefore, the controller 160 may perform the phase modulation mode to modulate the phase from 0° to 180°, and perform the frequency modulation mode with the phase modulated to 180° to modulate the frequency from 150 KHz to 70 KHz, thereby increasing the gain.

FIG. 10 is a graph for illustrating main waveforms according to phase modulation mode and frequency modulation mode operations when generating a resonance voltage according to an embodiment of the present disclosure.

FIG. 11 is a graph for illustrating main waveforms according to phase modulation mode and frequency modulation mode operations when generating regenerative voltage according to an embodiment of the present disclosure.

When converting power from the primary coil T1 of the transformer to the secondary coil T2 of the transformer, the controller 160 may control the first bridge switching unit 110 and the second bridge switching unit 130 to perform the phase modulation mode of modulating a phase to a target value, and perform the frequency modulation mode so as to overlap with a part of sections in which the phase is modulated to the target value.

When converting power from the secondary coil T2 of the transformer to the primary coil T1 of the transformer, the controller 160 may control the first bridge switching unit 110 and the second bridge switching unit 130 to perform the phase modulation mode of modulating a phase to a target value, and perform the frequency modulation mode so as to overlap with a part of sections in which the phase is modulated to the target value.

For example, referring to FIG. 12, the controller 160 may perform the phase modulation mode to modulate the phase from 0° to 180, and may modulate the frequency from 150 KHz to 70 KHz by performing the frequency modulation mode that overlaps with the phase modulation mode from the time when the phase is modulated to 170°.

Comparing the waveforms according to the control methods of the embodiments of the present disclosure, in the case that the input frequency is reduced in a phase modulated state, the amount of gain change in a section A of FIG. 13 between phase modulation and frequency modulation decreases, as shown in (a) of FIG. 13. On the other hand, in the case that the input frequency is reduced to overlap with some of the sections where the phase is modulated, the amount of gain change in a section B of FIG. 13 between phase modulation and frequency modulation increases consistently, as shown in the graph of FIG. 13(b), resulting in a stable output gain control.

Referring to FIG. 14, a power conversion method according to an embodiment of the present disclosure may include a phase modulation step (S210), a frequency modulation step (S220), and an output step (S230). In the phase modulation step (S210), the controller 160 performs the phase modulation mode by controlling the first bridge switching unit 110 or the second bridge switching unit 130. In the frequency modulation step (S220), the controller 160 performs the frequency modulation mode by controlling the first bridge switching unit 110 or the second bridge switching unit 130. In the output step (S230), the phase-modulated and frequency-modulated output voltage is outputted. In this exemplary embodiment, when converting power from the primary coil T1 of the transformer 150 to the secondary coil T2 of the transformer 150 or converting power from the secondary coil T2 of the transformer 150 to the primary coil T1 of the transformer 150, the controller 160 may control the first bridge switching unit 110 and the second bridge switching unit 130 to perform the phase modulation mode of modulating a phase to a preset target value in the phase modulation step (S210), and perform the frequency modulation mode of reducing the input frequency to a target value within a preset range in the frequency modulation step (S220).

In addition, the phase modulation step (S210) may include a plurality of sub-steps. For example, a first step of the phase modulation step (S210), the controller 160 turns on the first switching element S1 and the fourth switching element S4 and turns off the second switching element S2 and the third switching element S3 in a first section of a period. In a second step of the phase modulation step (S210), the controller 160 turns on the first switching element S1 and the third switching element S3 and turns off the second switching element S2 and the fourth switching element S4 in a second section of a period. In a third step of the phase modulation step (S210), the controller 160 turns on the second switching element S2 and the third switching element S3 and turns off the first switching element S1 and the fourth switching element S4 in a third section of a period. In a fourth step of the phase modulation step (S210), the controller 160 turns on the second switching element S2 and the fourth switching element S4 and turns off the first switching element S1 and the third switching element S3 in a fourth section of a period.

As described above, according to some embodiments of the present disclosure, it is possible to perform a stable output gain control from a light load to a full load by controlling using a complex modulation method in which a phase modulation mode and a frequency modulation mode are performed by a controller.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed is:

1. A power conversion device comprising:
a first bridge switch unit connected to a primary coil of a transformer and configured to perform full bridge switching;
a first resonance circuit comprising a first capacitor and a first inductor connected between the primary coil of the transformer and the first bridge switch unit;
a second bridge switch unit connected to a secondary coil of the transformer and configured to perform full bridge switching;
a second resonance circuit comprising a second capacitor and a second inductor connected between the secondary coil of the transformer and the second bridge switch unit; and
a controller configured to control the first bridge switch unit and the second bridge switch unit to generate a rectified resonance voltage by changing a voltage direction through the first bridge switch unit or to generate a rectified regenerative voltage by changing a voltage direction through the second bridge switch unit,
wherein the controller is configured to control the first bridge switch unit or the second bridge switch unit to perform a phase modulation mode for modulating a phase and a frequency modulation mode for modulating a frequency.

2. The power conversion device of claim 1,
wherein the first bridge switch unit comprises:
a first switch and a second switch connected in series to each other; and
a third switch and a fourth switch connected in parallel to the first switch and the second switch, and connected in series to each other,
wherein the first resonance circuit comprises:
the first inductor connected between the primary coil of the transformer and a first node of between the first switch and the second switch; and
the first capacitor connected between the primary coil of the transformer and a second node of between the third switch and the fourth switch, and
wherein two or more of the first to fourth switches are configured to be turned on or turned off in synchronization with each other.

3. The power conversion device of claim 2, wherein the controller is configured to, if the first bridge switch unit operates in the phase modulation mode or the frequency modulation mode, control the first switch and the second switch not to be turned on at a same time and control the third switch and the fourth switch not to be turned on at a same time.

4. The power conversion device of claim 2, wherein the first inductor of the first resonance circuit, the primary coil of the transformer, and the first capacitor of the first resonance circuit are connected in series.

5. The power conversion device of claim 1,
wherein the second bridge switch unit comprises:
a fifth switch and a sixth switch connected in series to each other; and
a seventh switch and an eighth switch connected in parallel to the fifth switch and the sixth switch, and connected in series to each other,
wherein the second resonance circuit comprises:
the second inductor connected between the secondary coil of the transformer and a third node of between the fifth switch and the sixth switch; and
the second capacitor connected between the secondary coil of the transformer and a fourth node of between the seventh switch and the eighth switch, and
wherein two or more of the fifth to eighth switches are configured to be turned on or turned off in synchronization with each other.

6. The power conversion device of claim 5, wherein the controller is configured to, if the second bridge switch unit operates in the phase modulation mode or the frequency modulation mode, control the fifth switch and the sixth switch not to be turned at a same time and control the seventh switch and the eighth switch not to be turned on at a same time.

7. The power conversion device of claim 5, wherein the second inductor of the second resonant circuit, the secondary coil of the transformer, and the second capacitor of the second resonant circuit are connected in series.

8. The power conversion device of claim 1, wherein the controller is configured to, when converting power from the primary coil of the transformer to the secondary coil of the transformer or converting power from the secondary coil of the transformer to the primary coil of the transformer, control the first bridge switch unit and the second bridge switch unit to perform the phase modulation mode for modulating the phase to a target value, and, when the phase is modulated to the target value, perform the frequency modulation mode.

9. The power conversion device of claim 1, wherein the controller is configured to, when converting power from the primary coil of the transformer to the secondary coil of the transformer or converting power from the secondary coil of the transformer to the primary coil of the transformer, control the first bridge switch unit and the second bridge switch unit to perform the phase modulation mode for modulating the phase to a target value and perform the frequency modulation mode so as to overlap with a part of sections in which the phase is modulated to the target value.

10. The power conversion device of claim 8, wherein the controller is configured to perform the frequency modulation mode to decrease an input frequency to the target value within a preset range.

11. The power conversion device of claim 2, wherein the controller is configured to perform the phase modulation mode by, when generating the rectified resonance voltage, turning on the first switch and the fourth switch and turning off the second switch and the third switch in a first section of a period.

12. The power conversion device of claim 2, wherein the controller is configured to perform the phase modulation mode by, when generating the rectified resonance voltage, turning on the first switch and the third switch and turning off the second switch and the fourth switch in a second section of a period.

13. The power conversion device of claim 2, wherein the controller is configured to perform the phase modulation mode by, when generating the rectified resonance voltage, turning on the second switch and the third switch and turning off the first switch and the fourth switch in a third section of a period.

14. The power conversion device of claim 2, wherein the controller is configured to perform the phase modulation mode by, when generating the rectified resonance voltage, turning on the second switch element and the fourth switch element and turning off the first switch element and the third switch element in a fourth section of a period.

15. The power conversion device of claim 5, wherein the controller is configured to perform the phase modulation mode by, when generating the rectified resonance voltage, conducting diodes of the fifth switch and the eighth switch and insulating diodes of the sixth switch and the seventh switch in a first section of a period.

16. The power conversion device of claim 5, wherein the controller is configured to perform the phase modulation mode by, when generating the rectified resonance voltage, conducting diodes of the fifth switch and the eighth switch and insulating diodes of the sixth switch and the seventh switch in a second section of a period.

17. The power conversion device of claim 5, wherein the controller is configured to perform the phase modulation mode by, when generating the rectified resonance voltage, conducting diodes of the sixth switch and the seventh switch and insulating diodes of the fifth switch and the eighth switch in a third section of a period.

18. The power conversion device of claim 5, wherein the controller is configured to perform the phase modulation mode by, when generating the rectified resonance voltage, conducting diodes of the fifth switch and the eighth switch and insulating diodes of the sixth switch and the seventh switch in a fourth section of a period.

19. A power conversion method for converting input direct current power to be stepped up or stepped down, the power conversion method comprising:
performing, by a controller, a phase modulation mode by controlling a first bridge switch unit or a second bridge switch unit; and
performing, by the controller, a frequency modulation mode by controlling the first bridge switch unit or the second bridge switch unit,
wherein the performing of the phase modulation mode comprises modulating a phase to a target phase value, and
wherein the performing of the frequency modulation mode comprises decreasing an input frequency to a target frequency value within a preset range.

20. The power conversion method of claim 19, wherein the performing of the phase modulation mode comprises:
by the controller, turning on a first switch and a fourth switch and turning off a second switch and a third switch in a first section of a period;
by the controller, turning on the first switch and the third switch and turning off the second switch and the fourth switch in a second section of the period;
by the controller, turning on the second switch element and the third switch element and turning off the first switch and the fourth switch in a third section of the period; and
by the controller, turning on the second switch and the fourth switch and turning off the first switch and the third switch in a fourth section of the period.
